(19) United States
(12) Patent Application Publication
(10) Pub. No.: US 2024/0255396 A1
(43) Pub. Date: Aug. 1, 2024

(54) Product Reliability Evaluation Method And Apparatus Based On Multi-Stress Coupling Acceleration Model

(71) Applicant: China Electronic Product Reliability and Environmental Testing Research Institute (The Fifth, Guangdong (CN)

(72) Inventors: Guangze Pan, Guangdong (CN); Xiaojian Ding, Guangdong (CN); Bochen Chen, Guangdong (CN); Dan Li, Guangdong (CN); Lijun Sun, Guangdong (CN); Yuanhang Wang, Guangdong (CN); Wenwei Liu, Guangdong (CN); Jianfeng Yang, Guangdong (CN)

(73) Assignee: China Electronic Product Reliability and Environmental Testing Research Institute(The Fifth elctroni, Guangdong (CN)

(21) Appl. No.: 18/426,853

(22) Filed: Jan. 30, 2024

(30) Foreign Application Priority Data
Feb. 1, 2023 (CN) 202310049470.6

(51) Int. Cl. G01N 3/02

(52) U.S. Cl. CPC G01N 3/02

(57) ABSTRACT

Disclosed are a fault prediction method and apparatus for a power conversion device, and a power conversion system. The method includes: acquiring multiple output voltages of a detecting coil in a preset time period, wherein an electromagnetic induction is generated between the detecting coil and a switching-on circuit of a switching transistor in the power conversion device; extracting each output frequency corresponding to each output voltage of the detecting coil; predicting time when the power conversion device fails according to a change trend of each output frequency. The apparatus includes a detecting coil and a data processing device; the detecting coil is connected to the data processing device and is a closed coil; the data processing device is configured to: acquire an output voltage of the detecting coil, extract corresponding output frequency, and predict time when the power conversion device fails according to a change trend of each output frequency.

### CROSS REFERENCE TO RELATED APPLICATION

The present application claims priority to Chinese Patent Application with No. 202310049470.6, entitled “Product Reliability Evaluation Method and Apparatus Based on Multi-Stress Coupling Acceleration Model”, and filed on Feb. 1, 2023, the content of which is expressly incorporated herein by reference in its entirety.

### TECHNICAL FIELD

The present disclosure relates to the field of reliability evaluation technology, and more particularly to a product reliability evaluation method and apparatus based on a multi-stress coupling acceleration model.

### BACKGROUND

The reliability evaluation of a product is an activity carried out in order to evaluate the product to maintain functional reliability in all environments, such as intended use, transportation, or storage, during a specified lifetime. By using various environmental test equipment to simulate the high temperature, low temperature, high temperature and high humidity, temperature change, and the like in the climate environment, the reaction of the state of the product in a use environment is accelerated to verify whether the product meets a quality target expected in the research, development, design, and manufacture, thereby evaluating the product to determine the reliability lifetime of the product.

In the conventional art, the reliability of a product is evaluated mainly by using a single stress acceleration model or a multi-stress acceleration model. However, the conventional method has a problem that the accuracy of the reliability evaluation is low because only the single stress or multiple independent stress acceleration tests are performed.

### SUMMARY

In view of the above, as for the above technical problem, it is necessary to provide a product reliability evaluation method and apparatus based on a multi-stress coupling acceleration model capable of improving the accuracy of the reliability evaluation of the product.

In the first aspect, the present disclosure provides a product reliability evaluation method based on a multi-stress coupling acceleration model, including: constructing a coupling competition failure model of a target product under an accelerated-stress test based on cumulative failure probability density functions corresponding to failure modes of the target product under the accelerated-stress test; substituting a solution result of a parameter in the coupling competition failure model into the coupling competition failure model to obtain the reliability function of the target product; integrating a function term of the reliability function to obtain an initial characteristic lifetime of the target product under the accelerated-stress test; determining the multi-stress coupling acceleration model of the target product based on the initial characteristic lifetime and a stress comprised in the accelerated-stress test; performing operation processing on the multi-stress coupling acceleration model to obtain a reliability of the target product.

In an embodiment, the constructing the coupling competition failure model of the target product under the accelerated-stress test based on the cumulative failure probability density functions corresponding to the failure modes of the target product under the accelerated-stress test may include: acquiring a cumulative failure probability density function corresponding to each failure mode of the target product under the accelerated-stress test; constructing the coupling competition failure model of the target product under the accelerated-stress test by using the cumulative failure probability density function corresponding to each failure mode based on a coupling competition relationship between the failure modes.

In an embodiment, the method may further include: before substituting the solution result of the parameter in the coupling competition failure model into the coupling competition failure model to obtain the reliability function of the target product, taking logarithms of functions on both sides of the coupling competition failure model to obtain a maximum likelihood function corresponding to the coupling competition failure model; solving the maximum likelihood function corresponding to the coupling competition failure model to obtain a solution result of an unknown parameter in the coupling competition failure model.

In an embodiment, the accelerated-stress test may include at least two stresses, and there may exist at least two groups of target products; and the method may further include: after the determining the multi-stress coupling acceleration model of the target product based on the initial characteristic lifetime and the stress comprised in the accelerated-stress test, acquiring a stress value of each stress applied to each group of target products; substituting an initial characteristic lifetime of each group of target products and the stress value of each stress into a model obtained after a linear transformation of the multi-stress coupling acceleration model, and obtaining an equation group consisting of a plurality of equations; solving the equation group to obtain a solution result of an unknown parameter in the multi-stress coupling acceleration model.

In an embodiment, the performing the operation processing on the multi-stress coupling acceleration model to obtain the reliability of the target product may include: determining a characteristic lifetime function of the target product; substituting a value of each normal stress into a function term of the characteristic lifetime function, performing the operation processing on the function term of the characteristic lifetime function, and obtaining the characteristic lifetime of the target product, wherein the characteristic lifetime represents a serviceable duration of the target product; determining mean time between failures of the target product under the normal stresses based on the characteristic lifetime when a distribution of the characteristic lifetime is an exponential distribution; obtaining the reliability of the target product according to a length of the mean time between failures.

In an embodiment, the determining the characteristic lifetime function of the target product may include: acquiring the number of stresses applied to the target product in the accelerated-stress test; obtaining the characteristic lifetime function of the target product based on the number of stresses and combined with the multi-stress coupling acceleration model and the solution result of the unknown parameter in the multi-stress coupling acceleration model.

In an embodiment, the method may further include: obtaining a failure rate of the target product under the normal stresses by taking a reciprocal of the characteristic lifetime of the target product, wherein the failure rate represents a probability that the target product fails.

In the second aspect, the present disclosure provides a product reliability evaluation apparatus based on a multi-stress coupling acceleration model, including: a coupling competition failure model construction module, configured to construct a coupling competition failure model of a target product under an accelerated-stress test based on cumulative failure probability density functions corresponding to failure modes of the target product under the accelerated-stress test; a reliability function determination module, configured to substitute a solution result of a parameter in the coupling competition failure model into the coupling competition failure model to obtain the reliability function of the target product; an initial characteristic lifetime calculation module, configured to integrate a function term of the reliability function to obtain an initial characteristic lifetime of the target product under the accelerated-stress test; a multi-stress coupling acceleration model construction module, configured to determine the multi-stress coupling acceleration model of the target product based on the initial characteristic lifetime and a stress comprised in the accelerated-stress test; a reliability obtaining module, configured to perform operation processing on the multi-stress coupling acceleration model to obtain a reliability of the target product.

In the third aspect, the present disclosure provides a computer device, including a processor and a memory storing a computer program, the processor, when executing the computer program, implements the method of any one of the above-mentioned embodiments.

In the fourth aspect, the present disclosure provides a computer-readable storage medium, on which a computer program is stored, when the computer program is executed by a processor, the processor is caused to implement the method of any one of the above-mentioned embodiments.

In the fifth aspect, the present application provides a computer program product including a computer program which, when executed by a processor, causes the processor to implement the method of any one of the above-mentioned embodiments.

With the product reliability evaluation method and apparatus based on the multi-stress coupling acceleration model, the coupling competition relationship among a plurality of failure modes of a target product can be accurately described through constructing the coupling competition failure model, to obtain a reliable multi-stress coupling acceleration model. By constructing the multi-stress coupling acceleration model of the target product according to the initial characteristic lifetime of the target product under the accelerated-stress test and the stresses included in the accelerated-stress test, the coupling relationship among a plurality of stresses applied to the target product can be well reflected, thereby improving the accuracy of the reliability evaluation of the target product.

### BRIEF DESCRIPTION OF THE DRAWINGS

FIG. 1 is an application environment diagram for a product reliability evaluation method based on a multi-stress coupling acceleration model according to an embodiment.

FIG. 2 is a flow chart showing a product reliability evaluation method based on a multi-stress coupling acceleration model according to an embodiment.

FIG. 3 is a flow chart showing a product reliability evaluation method based on a multi-stress coupling acceleration model according to another embodiment.

FIG. 4 is a schematic diagram of a product reliability evaluation apparatus based on a multi-stress coupling acceleration model according to an embodiment.

FIG. 5 is an internal structure diagram of a computer device according to an embodiment.

### DETAILED DESCRIPTION

In order to make the purpose, technical solution, and advantages of the present disclosure clearer, the present disclosure will be elaborated below with reference to the accompanying drawings and embodiments. It should be appreciated that the specific embodiments described herein are merely used for illustrating the present disclosure and are not intended to limit the present disclosure.

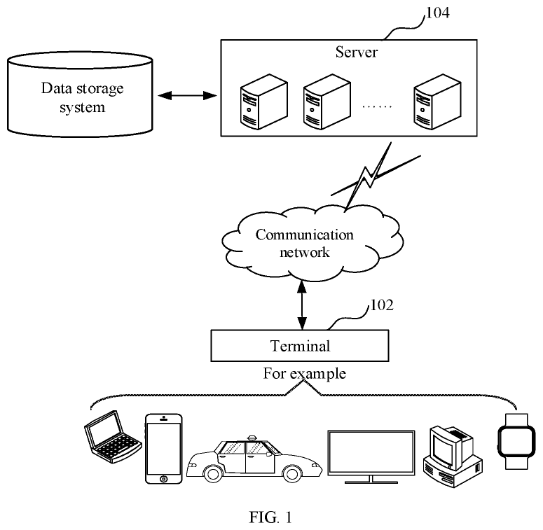

A product reliability evaluation method based on a multi-stress coupling acceleration model provided in the present embodiment can be applied to the application environment shown in FIG. 1. A terminal 102 communicates with a server 104 through a network. The data storage system may store data needing to be processed by the server 104. The data storage system may be integrated on the server 104, or may be placed on a cloud or other network server. The server 104 combines a cumulative failure probability density function corresponding to a failure mode of a target product under an accelerated-stress test experiment as a parameter to obtain a coupling competition failure model of the target product under the accelerated-stress test experiment. The server 104 solves an unknown parameter in the constructed coupling competition failure model and re-substitutes a solution result into the coupling competition failure model to obtain the reliability function of the target product. The server 104 integrates a function term of the reliability function of the target product to obtain an initial characteristic lifetime of the target product for the accelerated-stress test. The server 104 obtains the multi-stress coupling acceleration model of the target product according to the obtained initial characteristic lifetime and the stress applied to the target product in the accelerated-stress test. The server 104 obtains the reliability evaluation result of the target product according to an operation result of the multi-stress coupling acceleration model. The terminal 102 may be, but is not limited to, a variety of personal computers, laptops, smartphones, tablet computers, Internet of Things devices, and portable wearable devices. The Internet of Things devices may be intelligent sound boxes, intelligent televisions, intelligent air conditioners, intelligent vehicle-mounted devices, and the like. The portable wearable device may be a smart watch, a smart bracelet, a headset device, or the like. The server 104 may be implemented as an independent server or as a cluster of servers.

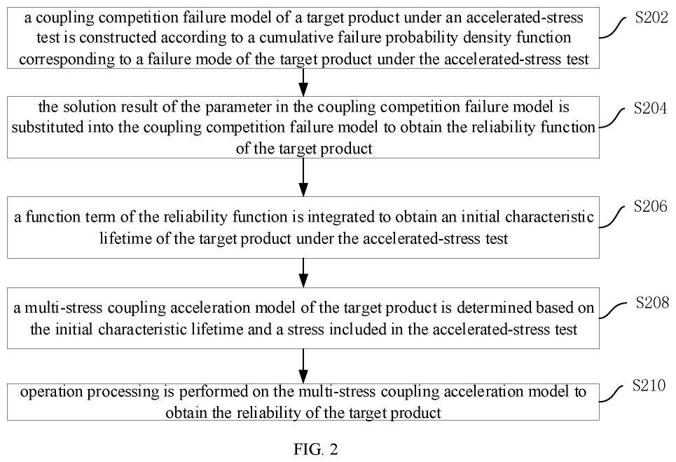

In an embodiment, as shown in FIG. 2, a product reliability evaluation method based on a multi-stress coupling acceleration model is provided, which is applied to the server 104 in FIG. 1 as an example, the method may include the following steps.

Step 202: a coupling competition failure model of a target product under an accelerated-stress test is constructed according to a cumulative failure probability density function corresponding to a failure mode of the target product under the accelerated-stress test.

The accelerated-stress test is a test method for accelerating aging of a product by applying a high temperature, a high humidity, and a high pressure to the product.

The failure mode mainly includes a degradation failure and a sudden failure. The degradation failure refers to a product failure caused by a performance exceeding a certain threshold, for example, a voltage gradually degrades to failure. The sudden failure refers to a sudden failure of a product, such as a sudden short circuit of a circuit.

The cumulative failure probability density function refers to a change rate function of the cumulative failure probability to time.

The coupling competition failure model is a model established based on a coupling competition relationship among a plurality of failure modes. The coupling represents a degree of association between two subsystems. When one subsystem changes, and this change has a small effect on the other subsystem, the two subsystems are loosely coupled. Conversely, the two subsystems are closely coupled when the effect is great. For example, when two or more circuits constitute a network in which a change in the current or voltage in one circuit may affect a similar change in other circuits, such network is referred to as a coupling circuit.

Optionally, the server performs the accelerated-stress test on the target product, and constructs a coupling competition failure model of the target product under the accelerated-stress test according to a cumulative failure probability density function corresponding to a failure mode under the accelerated-stress test and indicating a change rate of the cumulative failure probability to time, and a coupling competition relationship among various failure modes.

In a specific application, the product has n failure modes under the accelerated-stress testing, and n cumulative failure probability density functions of the n failure modes are respectively F₁(t), F₂(t), . . . , Fₙ(t); t is the time for the accelerated-stress test. Considering the coupling competition relationship among the n failure modes, the coupling competition failure model of the target product under the accelerated-stress test is as follows:

$$R ( t ) = C ( {R}_{1} ( t ) , {R}_{2} ( t ) , … , {R}_{u} ( t ) , θ ) = 1 - {\sum }_{j = 1}^{n} {F}_{j} ( t ) + {\sum }_{1 \leq j < k \leq t} C ( {F}_{j} ( t ) , {F}_{k} ( t ) , … ) - {\sum }_{1 \leq j \leq k \leq b \leq i} C ( {F}_{j} ( t ) , {F}_{k} ( t ) , {F}_{b} ( t ) , … ) + {( - 1 )}^{n} C ( {F}_{1} ( t ) , {F}_{2} ( t ) , … , {F}_{t} ( t ) ) . \qquad ( 1 )$$

In the above formula (1), R(t) is a reliability function of the target product, C(*) is a connection function, C(Fⱼ(t), Fₖ(t), . . . ) are connection functions in which all variables except Fⱼ(t) and Fₖ(t) are equal to 1, and 0 is an unknown parameter.

Step 204: the solution result of the parameter in the coupling competition failure model is substituted into the coupling competition failure model to obtain the reliability function of the target product.

The reliability function refers to a function of a probability that the product performs a specified function under a specified condition and within specified time. In terms of the probability distribution, the reliability function may also be referred to as a reliability distribution function.

Optionally, the server resubstitutes the solution result of the unknown parameter θ in the coupling competition failure model into the coupling competition failure model to obtain the reliability function of the coupling competition relationship among the plurality of failure modes of the target product under the accelerated-stress test.

Step 206: a function term of the reliability function is integrated to obtain an initial characteristic lifetime of the target product under the accelerated-stress test.

The initial characteristic lifetime is a special case of a reliable lifetime, which is the reliable lifetime with a reliability of 0.368.

Alternatively, the server integrates the function term of the reliability function representing the coupling competition relationship among the plurality of failure modes of the target product to obtain the initial characteristic lifetime of the target product under the accelerated-stress test.

In a specific application, the integral operation is performed on the function term of the reliability function R(t), and a formula of the integral operation is

$$η = {{\int }_{0}}^{∞} R ( t ) dt ,$$

accordingly the initial characteristic lifetime n of the target product under the accelerated-stress test is obtained.

Step 208: a multi-stress coupling acceleration model of the target product is determined based on the initial characteristic lifetime and a stress included in the accelerated-stress test.

The stress refers to an external force factor capable of accelerating a failure of the product. For example, a temperature stress and a humidity stress, and the like. The multi-stress coupling acceleration model is a model which takes into account a coupling relationship among various stresses.

Optionally, the server establishes the multi-stress coupling acceleration model of the target product under the accelerated-stress test according to the initial characteristic lifetime of the target product obtained from the experiment and the coupling competition relationship among the stresses applied on the target product during the accelerated-stress test.

In a specific application, a plurality of different stresses are applied to the target product to perform the accelerated-stress test, and one of the stresses is a temperature stress. The initial characteristic lifetime of each group of target products after the test is acquired, and the coupling relationship between the temperature stress and other non-temperature stresses is considered, then the multi-stress coupling acceleration model of the target product is as follows:

$${η}_{i} = A exp [ B / ( {kT}_{i} ) ] \times exp \{ {\sum }_{j = 1}^{m} {S}_{ij} [ {C}_{j} + {D}_{j} / ( {kT}_{i} ) ] \} . \qquad ( 2 )$$

In the above formula (2), m represents a total number of stresses other than the temperature stress, j=1, 2, . . . , m; Sᵢⱼ denotes a value of the j-th non-temperature stress for the accelerated-stress test of the i-th group of target products; A, B, Cⱼ, and Dⱼ denote unknown parameters; Tᵢ denotes a value of the temperature stress for the accelerated-stress test of the i-th group of target products; ηᵢ denotes the initial characteristic lifetime of the i-th group of target products under the accelerated-stress test; and k is a Boltzmann constant.

Step 210: operation processing is performed on the multi-stress coupling acceleration model to obtain the reliability of the target product.

Alternatively, the server calculates the characteristic lifetime of the target product and mean time between failures by using the obtained multi-stress coupling acceleration model, so that the reliability evaluation result of the target product is obtained.

In the product reliability evaluation method based on the multi-stress coupling acceleration model, the coupling competition relationship among a plurality of failure modes of the target product can be accurately described by constructing the coupling competition failure model, to obtain a reliable multi-stress coupling acceleration model. By constructing the multi-stress coupling acceleration model of the target product according to the initial characteristic lifetime of the target product under the accelerated-stress test and the stress included in the accelerated-stress test, the coupling relationship among a plurality of stresses applied to the target product can be well reflected, thereby improving the reliability evaluation accuracy of the target product.

In an embodiment, the step of constructing the coupling competition failure model of the target product under the accelerated-stress test based on the cumulative failure probability density function corresponding to the failure modes of the target product under the accelerated-stress testing may include:
a cumulative failure probability density function corresponding to each failure mode of the target product under the accelerated-stress test is acquired;
the coupling competition failure model of the target product under the accelerated-stress test is constructed by using the cumulative failure probability density function corresponding to each failure mode based on the coupling competition relationship between the failure modes.

The coupling competition relationship refers to an interactional relationship between two failure modes. For example, the failure mode 1 may affect the failure mode 2, and there exists a coupling competition relationship between the failure mode 1 and the failure mode 2.

Optionally, the server may construct the coupling competition failure model of the target product under the accelerated-stress test according to the interactional relationship among the various failure modes of the target product under the accelerated-stress test, and the cumulative failure probability density functions corresponding to the various failure modes.

In the present embodiment, by constructing the coupling competition failure model with the cumulative failure probability density functions corresponding to the various failure modes, the coupling competition relationship among various failure modes can be accurately described, so that the coupling competition failure model is more accurate.

In an embodiment, before the step of substituting the solution result of the parameter in the coupling competition failure model into the coupling competition failure model to obtain the reliability function of the target product, the method may further include:
logarithms of functions on both sides of the coupling competition failure model are taken to obtain a maximum likelihood function corresponding to the coupling competition failure model;
the maximum likelihood function corresponding to the coupling competition failure model is solved to obtain a solution result of an unknown parameter in the coupling competition failure model.

Optionally, the server takes the logarithms of functions on both sides of the equation of the coupling competition failure model obtained based on the coupling competition relationship among the various failure modes, to obtain the maximum likelihood function corresponding to the coupling competition failure model; and the server solves the maximum likelihood function of the coupling competition failure model to obtain a value of an unknown parameter θ in the coupling competition failure model.

In the present embodiment, by solving the unknown parameter in the coupling competition failure model with the maximum likelihood function, the process of solving the parameter can be simplified, so that the value of the unknown parameter in the coupling competition failure model can be quickly obtained.

In an embodiment, the accelerated-stress test may include at least two stresses, and there may exist at least two groups of target products.

After the step of determining the multi-stress coupling acceleration model of the target product based on the initial characteristic lifetime and the stress included in the accelerated-stress test, the method may further include:
a stress value of each stress applied to each group of target products is acquired;
an initial characteristic lifetime of each group of target products and the stress value of each stress are substituted into a model obtained after a linear transformation of the multi-stress coupling acceleration model, and an equation group consisting of a plurality of equations is obtained;
the equation group is solved to obtain a solution result of an unknown parameter in the multi-stress coupling acceleration model.

The stress value of each stress refers to a value of an applied stress. For example, a temperature stress with a stress value of 65 degrees is applied to the target product. As another example, a moisture stress with a stress value of 30% is applied to the target product.

The linear transformation is to take the logarithms of both sides of the equation of the multi-stress coupling acceleration model. The maximum likelihood function corresponding to the multi-stress coupling acceleration model can be obtained by performing the linear transformation on the multi-stress coupling acceleration model.

Optionally, the server takes the logarithms of the functions on both sides of the equation of the multi-stress coupling acceleration model

$$η = A exp [ B / ( {kT}_{i} ) ] \times exp \{ {\sum }_{j = 1}^{m} {S}_{ij} [ {C}_{j} + {D}_{j} / ( {kT}_{i} ] \} ,$$

and the maximum likelihood function corresponding to the obtained multi-stress coupling acceleration model is:

$$ln {η}_{i} = {γ}_{0} + {γ}_{1} \times {φ}_{1} ( {T}_{i} ) + {\sum }_{j = 1}^{m} {γ}_{2 j} \times {φ}_{2 j} ( {S}_{ij} ) + {\sum }_{j = 1}^{m} {γ}_{3 j} \times {φ}_{3} ( {T}_{1} ) {φ}_{2 j} ( {S}_{ij} ) . \qquad ( 3 )$$

In the above formula (3), m represents a total number of stresses other than the temperature stress, and j=1, 2, . . . , m; Sᵢⱼ denotes the value of the j-th non-temperature stress of the i-th group of target products during the accelerated-stress test, and φ₂ⱼ(Sᵢⱼ)=Sᵢⱼ; Tᵢ denotes the value of the temperature stress of the i-th group of target products during the accelerated-stress test, and φ₁(Tᵢ)φ₂ⱼ(Sᵢⱼ)=Sᵢⱼ/Tᵢ; φ₁(Tᵢ)φ₂ⱼ(Sᵢⱼ) is an interaction term and can reflect the coupling relationship between the temperature stress and other stresses; ηᵢ denotes the initial characteristic lifetime of the i-th group of target products during accelerated-stress test; k denotes a Boltzmann constant; γ₀=lnA, γ₁=B/k, γ₂ⱼ=Cⱼ, and γ₃ⱼ=Dⱼ/k are unknown parameters in the multi-stress coupling acceleration model.

The server substitutes the initial characteristic lifetime of each group of target products and the value of the stress applied to each group of target products during the accelerated-stress test into the maximum likelihood function corresponding to the multi-stress coupling accelerated model, and obtains an equation group consisting of a plurality of equations. The server solves the parameters in the equation group by using a parameter estimation solving method, to obtain solution results of unknown parameters in the multi-stress coupling acceleration model.

In a specific application, there are p groups of target products for the accelerated-stress test, and the stresses of the groups are respectively represented as (T₁, S₁₁, S₁₂, . . . , S₁ⱼ, . . . , S₁ₘ), (T₂, S₂₁, S₂₂, . . . , S₂ⱼ, . . . , S₂ₘ), . . . , (Tᵢ, Sᵢ₁, Sᵢ₂, . . . , Sᵢⱼ, . . . , S₁ₘ), . . . , (Tₚ, Sₚ₁, Sₚ₂, . . . , Sₚⱼ, . . . , Sₚₘ). The characteristic lifetimes of the groups are respectively represented as η₁, η₂, . . . , ηᵢ, . . . , ηₚ. All these data is substituted into the maximum likelihood function corresponding to the multi-stress coupling acceleration model to obtain the equation group as follows:

$$\{ \begin{matrix}ln {η}_{1} = {γ}_{0} + {γ}_{1} \times {φ}_{1} ( {T}_{1} ) + {\sum }_{j = 1}^{m} {γ}_{2 j} \times {φ}_{2 j} ( {S}_{1 j} ) + {\sum }_{j = 1}^{m} {γ}_{3 j} \times {φ}_{1} ( {T}_{1} ) {φ}_{2 j} ( {S}_{1 j} ) \\ ln {η}_{2} = {γ}_{0} + {γ}_{1} \times {φ}_{1} ( {T}_{2} ) + {\sum }_{j = 1}^{m} {γ}_{2 j} \times {φ}_{2 j} ( {S}_{2 j} ) + {\sum }_{j = 1}^{m} {γ}_{3 j} \times {φ}_{1} ( {T}_{2} ) {φ}_{2 j} ( {S}_{2 j} ) \\ … \\ ln {η}_{i} = {γ}_{0} + {γ}_{1} \times {φ}_{1} ( {T}_{i} ) + {\sum }_{j = 1}^{m} {γ}_{2 j} \times {φ}_{2 j} ( {S}_{i j} ) + {\sum }_{j = 1}^{m} {γ}_{3 j} \times {φ}_{1} ( {T}_{i} ) {φ}_{2 j} ( {S}_{ij} ) \\ … \\ ln {η}_{p} = {γ}_{0} + {γ}_{1} \times {φ}_{1} ( {T}_{p} ) + {\sum }_{j = 1}^{m} {γ}_{2 j} \times {φ}_{2 j} ( {S}_{p j} ) + {\sum }_{j = 1}^{m} {γ}_{3 j} \times {φ}_{1} ( {T}_{p} ) {φ}_{2 j} ( {S}_{p j} )\end{matrix} . \qquad ( 4 )$$

The server solves the equation group (4) by using the parameter estimation solving method to obtain solution results of the unknown parameters γ₀, γ₁, γ₂ⱼ, and γ₃ⱼ in the multi-stress coupling acceleration model.

In the embodiment, the unknown parameters in the multi-stress coupling acceleration model are solved in the form of the equation group, accordingly the solving process of the parameters can be simplified, thereby increasing the rate at which the parameter results are obtained.

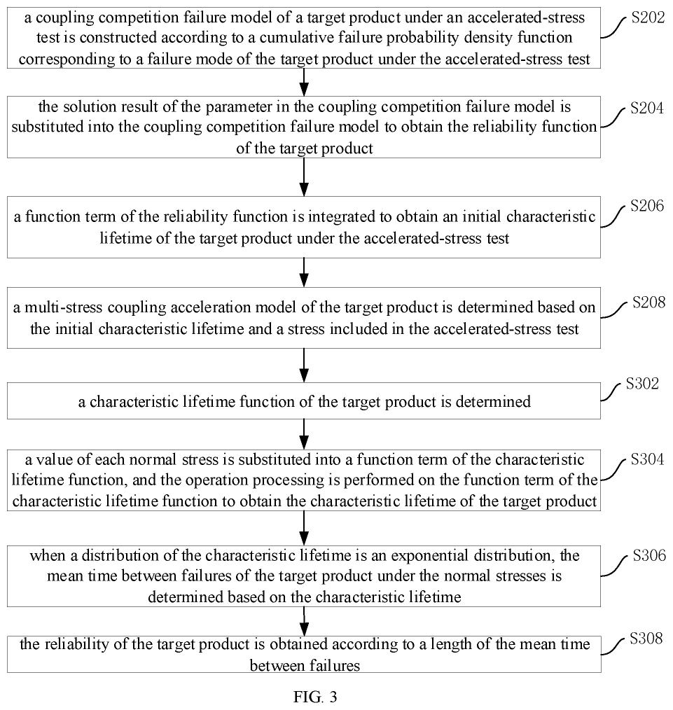

In an embodiment, as shown in FIG. 3, the step of performing the operation processing on the multi-stress coupling acceleration model to obtain the reliability of the target product may include:

step 302: a characteristic lifetime function of the target product is determined.

The characteristic lifetime function is a formula for calculating the characteristic lifetime of the target product, and is obtained according to the multi-stress coupling acceleration model. For example, according to the parameter results of the parameters in the multi-stress coupling acceleration model and the multi-stress coupling acceleration model obtained by performing a two-stress accelerated test on the target product, the characteristic lifetime function of the target product under the normal stresses can be obtained as follows: η₀=exp[γ₀+γ₁*φ₁(T₀)+γ₂*φ₂(S₀)+γ₃*φ₁(T₀)φ₂(S₀)]; γ₀, γ₁, γ₂ and γ₃ are known parameters in the characteristic lifetime function; T₀ denotes a temperature value under the normal stresses, S₀ denotes a value of a non-temperature stress under the normal stresses; and η₀ denotes the characteristic lifetime of the target product. For another example, according to the parameter results of the parameters in the multi-stress coupling acceleration model and the multi-stress coupling acceleration model obtained by performing a multi-stress accelerated test on the target product, the characteristic lifetime function of the target product under the normal stresses can be obtained as follows:

$${η}_{0} = exp [ {γ}_{0} + {γ}_{1} \times {φ}_{1} ( {T}_{0} ) + {\sum }_{j = 1}^{m} {γ}_{2 j} \times {φ}_{2 j} ( {S}_{0 j} ) + {\sum }_{j = 1}^{m} {γ}_{3 j} \times {φ}_{1} ( {T}_{0} ) {φ}_{2 j} ( {S}_{0 j} ) ] ;$$

where γ₀, γ₁, γ₂ⱼ and γ₃ⱼ are known parameters in the characteristic lifetime function; T₀ is the temperature value under the normal stresses; S₀ⱼ is a value of the j-th non-temperature stress under the normal stresses; and η₀ is the characteristic lifetime of the target product.

Step 304: a value of each normal stress is substituted into a function term of the characteristic lifetime function, and the operation processing is performed on the function term of the characteristic lifetime function to obtain the characteristic lifetime of the target product; the characteristic lifetime is configured to represent a serviceable duration of the target product.

The normal stress refers to a case where there is no interference with the target product. For example, the temperature in the actual environment is 25 degrees, and the value of the temperature stress of the target product under the normal stresses is also 25 degrees.

Alternatively, the server obtains a normal stresses value of each stress applied to the target product in the actual environment without any interference to the target product, and substitutes the normal stresses value into the characteristic lifetime function. The server can obtain the characteristic lifetime representing the serviceable duration of the target product by calculating the characteristic lifetime function substituted with the specific data.

Step 306: when a distribution of the characteristic lifetime is an exponential distribution, the mean time between failures of the target product under the normal stresses is determined based on the characteristic lifetime.

The mean time between failures refers to an average duration of a normal operation of the product or system during an interval between two adjacent failures, which is also referred to as mean operating time between failures, i.e., an amount indicating how long the product or system can operate on average.

Alternatively, when the server detects that the characteristic lifetime distribution of the target product is an exponential distribution, the characteristic lifetime of the target product is directly determined as the mean time between failures of the target product, that is, the characteristic lifetime of the target product is equal to the mean time between failures.

Step 308: the reliability of the target product is obtained according to a length of the mean time between failures.

Alternatively, the server evaluates the reliability of the target product based on the length of the mean time between failures. If the length of the mean time between failures is longer, it indicates that the reliability of the target product is better; on the contrary, the reliability of the target product is worse.

In the embodiment, the characteristic lifetime of the target product under the normal stresses can be accurately calculated by using the characteristic lifetime function obtained according to the multi-stress coupling acceleration model, thereby improving the accuracy of the reliability evaluation of the target product.

In an embodiment, the step of determining the characteristic lifetime function of the target product may include:
the number of stresses applied to the target product in the accelerated-stress test is acquired;
the characteristic lifetime function of the target product is obtained based on the number of stresses and combined with the multi-stress coupling acceleration model and parameter results of unknown parameters in the multi-stress coupling acceleration model.

Alternatively, the server can determine a framework of the characteristic lifetime function according to the number of stresses applied to the target product in the accelerated-stress test and the constructed multi-stress coupling acceleration model, and then substitutes the parameter results of the unknown parameters in the multi-stress coupling acceleration model into the framework of the characteristic lifetime function to obtain the characteristic lifetime function of the target product.

In the embodiment, by constructing the characteristic lifetime function according to the multi-stress coupling acceleration model and the number of stresses applied, the characteristic lifetime function can accurately calculate the characteristic lifetime of the target product, thereby improving the accuracy of the reliability evaluation of the target product.

In an embodiment, the product reliability evaluation method based on the multi-stress coupling acceleration model may further include:
a reciprocal of the characteristic lifetime of the target product is taken to obtain a failure rate of the target product under the normal stresses. The failure rate represents a probability that the target product fails.

Optionally, the server performs reciprocal processing on the value of the characteristic lifetime of the target product to obtain a reciprocal value of the characteristic lifetime, that is, a probability of failure of the target product in unit time under the normal stresses.

In the embodiment, by obtaining the reciprocal of the characteristic lifetime of the target product, it is possible to obtain the probability of failure of the target product in unit time under the normal stresses.

The present application also provides an application scenario in which the above-mentioned product reliability evaluation method based on the multi-stress coupling acceleration model is applied. Specifically, the application of the product reliability evaluation method based on the multi-stress coupling acceleration model in the application scenario is described as follows: the accelerated-stress test is performed on the target product under a comprehensive action of both temperature stress and humidity stress, the number of test groups is 5, and the test stress of each group is shown in Table 1.

TABLE 1
accelerated-stress test

| Serial number | Accelerated-stress test |
|---|---|
| Group 1 | temperature T₁ = 85° C., humidity RH₁ = 95% |
| Group 2 | temperature T₂ = 85° C., humidity RH₂ = 85% |
| Group 3 | temperature T₃ = 75° C., humidity RH₃ = 95% |
| Group 4 | temperature T₄ = 85° C., humidity RH₄ = 75% |
| Group 5 | temperature T₅ = 65° C., humidity RH₅ = 95% |

The accelerated-stress test of the second group is illustrated as an example, the target product has two failure modes under the accelerated-stress test, and the cumulative failure probability density functions of the two failure modes are respectively F₁(t) and F₂(t), and the coupling competition failure model of the second group of target products is R(t)=1−F₁(t)−F₂(t)+C (F₁(t), F₂(t), θ). The value of the unknown parameter θ is obtained by solving the maximum likelihood function, and the value of the parameter θ is substituted into the coupling competition failure model to obtain the reliability function of the second group of target products. The function term of the reliability function of the second group of target products is integrated to obtain that the initial characteristic lifetime of the second group of target products under the accelerated-stress test is η₂. Initial characteristic lifetimes of the remaining groups of target products under the accelerated-stress test are obtained by using the same method, namely η₁, η₃, η₄ and η₅, respectively.

The multi-stress coupling acceleration model is established according to the initial characteristic lifetime of each group of target products under the accelerated-stress test and the applied stresses as follows: lnηᵢ=γ₀+γ₁/T₁+γ₂*lnRHᵢ+γ₃*Tᵢ*lnRHᵢ where RHᵢ denotes a value of the humidity stress of the i-th group. Logarithms of both sides of the equation of the multi-stress coupling acceleration model are taken, a maximum likelihood function corresponding to the multi-stress coupling acceleration model is obtained; and the initial characteristic lifetime of each group of target products under the accelerated-stress test and the stress value of each applied stress are substituted into the maximum likelihood function corresponding to the multi-stress coupling acceleration model to obtain the equation group as follows:

$$\{ \begin{matrix}ln {η}_{1} = {γ}_{0} + {γ}_{1} / {T}_{1} + {γ}_{2} \times ln {RH}_{1} + {γ}_{3} / {T}_{1} \times ln {RH}_{1} \\ ln {η}_{2} = {γ}_{0} + {γ}_{1} / {T}_{2} + {γ}_{2} \times ln {RH}_{2} + {γ}_{3} / {T}_{1} \times ln {RH}_{2} \\ ln {η}_{3} = {γ}_{0} + {γ}_{1} / {T}_{3} + {γ}_{2} \times ln {RH}_{3} + {γ}_{3} / {T}_{1} \times ln {RH}_{3} \\ ln {η}_{4} = {γ}_{0} + {γ}_{1} / {T}_{1} + {γ}_{2} \times ln {RH}_{4} + {γ}_{3} / {T}_{1} \times ln {RH}_{4} \\ ln {η}_{5} = {γ}_{0} + {γ}_{1} / {T}_{5} + {γ}_{2} \times ln {RH}_{5} + {γ}_{3} / {T}_{1} \times ln {RH}_{5}\end{matrix} .$$

By solving the above equation group, the values of parameters γ₀, γ₁, γ₂, and γ₃ in the multi-stress coupling acceleration model are obtained. The characteristic lifetime function is constructed under the normal stresses of the target product, and the stress value of each normal stress is substituted into the characteristic lifetime function to obtain the characteristic lifetime η₀ of the target product under the normal stresses. The mean time between failures of the target product under the normal stresses is determined according to the characteristic lifetime η₀ of the target product, and the reliability of the target product is determined according to the mean time between failures of the target product.

It should be appreciated that although the steps in the flow charts involved in the embodiments described above are shown in sequence as indicated by the arrows, these steps are not definitely performed in sequence as indicated by the arrows. Unless expressly stated herein, these steps are not performed in a strict order and may be performed in other orders. Moreover, at least part of the steps in the flow charts referred to in the embodiments described above may include a plurality of steps or phases, which are not definitely performed at the same moment, but may be performed at different moments, and these steps or phases are not definitely performed in sequence, but may be performed in turns or alternately with other steps or at least part of steps or phases in other steps.

Based on the same inventive concept, an embodiment of the present disclosure further provides a product reliability evaluation apparatus based on a multi-stress coupling acceleration model for implementing the above-mentioned product reliability evaluation method based on the multi-stress coupling acceleration model. The solution provided by the apparatus is similar to the solution described in the above method. Therefore, as for specific limitations in one or more embodiments of the product reliability evaluation apparatus based on the multi-stress coupling acceleration model provided below, reference can be made to the above limitations on the product reliability evaluation method based on the multi-stress coupling acceleration model, and the details are not repeated herein.

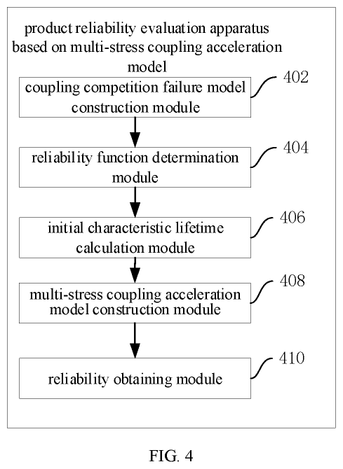

In an embodiment, as shown in FIG. 4, a product reliability evaluation apparatus based on a multi-stress coupling acceleration model is provided, which may include:
a coupling competition failure model construction module 402, configured to construct a coupling competition failure model of a target product under an accelerated-stress test according to a cumulative failure probability density function corresponding to a failure mode of the target product under the accelerated-stress test;
a reliability function determination module 404, configured to substitute a solution result of a parameter in the coupling competition failure model into the coupling competition failure model to obtain the reliability function of the target product;
an initial characteristic lifetime calculation module 406, configured to integrate a function term of the reliability function to obtain an initial characteristic lifetime of the target product under the accelerated-stress test;
a multi-stress coupling acceleration model construction module 408, configured to determine the multi-stress coupling acceleration model of the target product based on the initial characteristic lifetime and a stress included in the accelerated-stress test;
a reliability obtaining module 410, configured to perform operation processing on the multi-stress coupling acceleration model to obtain the reliability of the target product.

In an embodiment, the coupling competition failure model construction module may include:
a cumulative failure probability density function acquisition unit, configured to acquire a cumulative failure probability density function corresponding to each failure mode of the target product under the accelerated-stress test;
a coupling competition failure model construction unit, configured to construct the coupling competition failure model of the target product under the accelerated-stress test by using the cumulative failure probability density function corresponding to each failure mode based on a coupling competition relationship between the failure modes.

In an embodiment, the reliability function determination module may include:
a maximum likelihood function acquisition unit, configured to take logarithms of functions on both sides of the coupling competition failure model to obtain a maximum likelihood function corresponding to the coupling competition failure model;
a solution result obtaining unit, configured to solve the maximum likelihood function corresponding to the coupling competition failure model to obtain a solution result of an unknown parameter in the coupling competition failure model.

In an embodiment, the multi-stress coupling acceleration model construction module may include:
a stress value acquisition unit, configured to acquire a stress value of each stress applied to each group of target products;
an equation group determination unit, configured to substitute an initial characteristic lifetime of each group of target products and the stress value of each stress into a model obtained after a linear transformation of the multi-stress coupling acceleration model, and obtain an equation group consisting of a plurality of equations;
a parameter result obtaining unit, configured to solve the equation group to obtain a solution result of an unknown parameter in the multi-stress coupling acceleration model.

In an embodiment, the reliability acquisition module may include:
a characteristic lifetime function determination unit, configured to determine a characteristic lifetime function of the target product;
a characteristic lifetime calculation unit, configured to substitute a value of each normal stress into a function term of the characteristic lifetime function, perform operation processing on the function term of the characteristic lifetime function, and obtain the characteristic lifetime of the target product;
a mean time between failures determination unit, configured to determine the mean time between failures of the target product under the normal stresses based on the characteristic lifetime when a distribution of the characteristic lifetime is an exponential distribution;
a reliability obtaining unit, configured to obtain the reliability of the target product according to a length of the mean time between failures.

In an embodiment, the characteristic lifetime function determination unit may include:
a stress number acquisition subunit, configured to acquire the number of stresses applied to the target product in the accelerated-stress test;
a characteristic lifetime function determination subunit, configured to obtain the characteristic lifetime function of the target product based on the number of stresses and combined with the multi-stress coupling acceleration model and a parameter result of an unknown parameter in the multi-stress coupling acceleration model.

In an embodiment, the product reliability evaluation apparatus based on the multi-stress coupling acceleration model may further include:
a failure rate obtaining unit, configured to obtain a failure rate of the target product under the normal stresses by taking a reciprocal of the characteristic lifetime of the target product.

Various modules in the above-mentioned product reliability evaluation apparatus based on the multi-stress coupling acceleration model can be all or partially implemented by software, hardware, or combinations thereof. The modules may be embedded in or independent of a processor in a computer device in the form of hardware, or may be stored in a memory of the computer device in the form of software, to facilitate the processor to invoke and perform operations corresponding to the various modules.

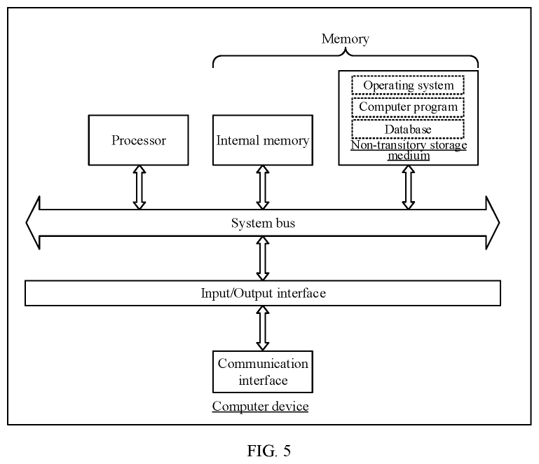

In an embodiment, a computer device is provided, which may be a server, and the internal structure of which may be shown in FIG. 5. The computer device may include a processor, a memory, an Input/Output (I/O) interface, and a communication interface. The processor, the memory and the input/output interface are connected to each other through a system bus, and the communication interface is connected to the system bus through the input/output interface. The processor of the computer device is configured to provide computing and control capabilities. The memory of the computer device includes a non-transitory storage medium and an internal memory. The non-transitory storage medium stores an operating system, a computer program, and a database. The internal memory provides an environment for the operations of an operating system and the computer program in the non-transitory storage medium. The database of the computer device is configured to store a failure mode of the target product under an accelerated-stress test, an accumulated failure probability density function corresponding to the failure mode, a coupled competition failure model, a solution result, a reliability function of the target product, an initial characteristic lifetime of the target product under the accelerated-stress test, a stress included in the accelerated-stress test, a multi-stress coupling acceleration model, a reliability of the target product, a characteristic lifetime function, a characteristic lifetime of the target product, and mean time between failures of the target product under normal stresses. The input/output interface of the computer device is configured to exchange information between the processor and an external device. The communication interface of the computer device is configured to communicate with an external terminal through a network connection. The computer program is executed by the processor to implement a product reliability evaluation method and apparatus based on a multi-stress coupling acceleration model.

It will be appreciated by those skilled in the art that the structure shown in FIG. 5 is merely a partial structure associated with the solution of the present disclosure, and does not constitute a limitation on the computer device on which the solution of the present disclosure is applied, and the specific computer device may include more or less components than those shown in the figures, or may combine certain components, or have different component arrangements.

In an embodiment, a computer device is provided, which may include a processor and a memory for storing a computer program, the processor, when executing the computer program, performs the following steps of:
constructing a coupling competition failure model of a target product under an accelerated-stress test according to a cumulative failure probability density function corresponding to a failure mode of the target product under the accelerated-stress test; substituting a solution result of a parameter in the coupling competition failure model into the coupling competition failure model to obtain the reliability function of the target product; integrating a function term of the reliability function to obtain an initial characteristic lifetime of the target product under the accelerated-stress test; determining the multi-stress coupling acceleration model of the target product based on the initial characteristic lifetime and a stress included in the accelerated-stress test; and performing operation processing on the multi-stress coupling acceleration model to obtain the reliability of the target product.

In an embodiment, the processor, when executing the computer program, may further implement the following steps of:
acquiring a cumulative failure probability density function corresponding to each failure mode of the target product under the accelerated-stress test; constructing the coupling competition failure model of the target product under the accelerated-stress test by using the cumulative failure probability density function corresponding to each failure mode based on a coupling competition relationship between the failure modes.

In an embodiment, the processor, when executing the computer program, may further implement the following steps of:
taking logarithms of functions on both sides of the coupling competition failure model to obtain a maximum likelihood function corresponding to the coupling competition failure model; solving the maximum likelihood function corresponding to the coupling competition failure model to obtain a solution result of an unknown parameter in the coupling competition failure model.

In an embodiment, the processor, when executing the computer program, may further implement the following steps of:
acquiring a stress value of each stress applied to each group of target products; substituting an initial characteristic lifetime of each group of target products and the stress value of each stress into a model obtained after a linear transformation of the multi-stress coupling acceleration model, and obtaining an equation group consisting of a plurality of equations; solving the equation group to obtain a solution result of an unknown parameter in the multi-stress coupling acceleration model.

In an embodiment, the processor, when executing the computer program, may further implement the following steps of:
determining a characteristic lifetime function of the target product; substituting a value of each normal stress into a function term of the characteristic lifetime function, performing operation processing on the function term of the characteristic lifetime function, and obtaining the characteristic lifetime of the target product; determining the mean time between failures of the target product under the normal stresses based on the characteristic lifetime when a distribution of the characteristic lifetime is an exponential distribution; obtaining the reliability of the target product according to a length of the mean time between failures.

In an embodiment, the processor, when executing the computer program, may further implement the following steps of:
acquiring the number of stresses applied to the target product in the accelerated-stress test; obtaining the characteristic lifetime function of the target product based on the number of stresses and combined with the multi-stress coupling acceleration model and the solution result of an unknown parameter in the multi-stress coupling acceleration model.

In an embodiment, the processor, when executing the computer program, may further implement the following steps of:
obtaining a failure rate of the target product under the normal stresses by taking a reciprocal of the characteristic lifetime of the target product.

In an embodiment, a computer-readable storage medium is provided, on which a computer program is stored, when the computer program is executed by a processor, the processor may be caused to implement the following steps of:
constructing a coupling competition failure model of a target product under an accelerated-stress test according to a cumulative failure probability density function corresponding to a failure mode of the target product under the accelerated-stress test; substituting a solution result of a parameter in the coupling competition failure model into the coupling competition failure model to obtain the reliability function of the target product; integrating a function term of the reliability function to obtain an initial characteristic lifetime of the target product under the accelerated-stress test; determining the multi-stress coupling acceleration model of the target product based on the initial characteristic lifetime and a stress included in the accelerated-stress test; and performing operation processing on the multi-stress coupling acceleration model to obtain the reliability of the target product.

In an embodiment, the computer program, when executed by the processor, may cause the processor to further implement the following steps of:
acquiring a cumulative failure probability density function corresponding to each failure mode of the target product under the accelerated-stress test; constructing the coupling competition failure model of the target product under the accelerated-stress test by using the cumulative failure probability density function corresponding to each failure mode based on a coupling competition relationship between the failure modes.

In an embodiment, the computer program, when executed by the processor, may cause the processor to further implement the following steps of:
taking logarithms of functions on both sides of the coupling competition failure model to obtain a maximum likelihood function corresponding to the coupling competition failure model; solving the maximum likelihood function corresponding to the coupling competition failure model to obtain a solution result of an unknown parameter in the coupling competition failure model.

In an embodiment, the computer program, when executed by the processor, may cause the processor to further implement the following steps of:
acquiring a stress value of each stress applied to each group of target products; substituting an initial characteristic lifetime of each group of target products and the stress value of each stress into a model obtained after a linear transformation of the multi-stress coupling acceleration model, and obtaining an equation group consisting of a plurality of equations; solving the equation group to obtain a solution result of an unknown parameter in the multi-stress coupling acceleration model.

In an embodiment, the computer program, when executed by the processor, may cause the processor to further implement the following steps of:
determining a characteristic lifetime function of the target product; substituting a value of each normal stress into a function term of the characteristic lifetime function, performing operation processing on the function term of the characteristic lifetime function, and obtaining the characteristic lifetime of the target product; determining the mean time between failures of the target product under the normal stresses based on the characteristic lifetime when a distribution of the characteristic lifetime is an exponential distribution; obtaining the reliability of the target product according to a length of the mean time between failures.

In an embodiment, the computer program, when executed by the processor, may cause the processor to further implement the following steps of:
acquiring the number of stresses applied to the target product in the accelerated-stress test; obtaining the characteristic lifetime function of the target product based on the number of stresses and combined with the multi-stress coupling acceleration model and a solution result of an unknown parameter in the multi-stress coupling acceleration model.

In an embodiment, the computer program, when executed by the processor, may cause the processor to further implement the following steps of:
obtaining a failure rate of the target product under the normal stresses by taking a reciprocal of the characteristic lifetime of the target product.

In an embodiment, a computer program product is provided, which may include a computer program, when the computer program is executed by a processor, the processor may be caused to implement the following steps of:
constructing a coupling competition failure model of a target product under an accelerated-stress test according to a cumulative failure probability density function corresponding to a failure mode of the target product under the accelerated-stress test; substituting a solution result of a parameter in the coupling competition failure model into the coupling competition failure model to obtain the reliability function of the target product; integrating a function term of the reliability function to obtain an initial characteristic lifetime of the target product under the accelerated-stress test; determining the multi-stress coupling acceleration model of the target product based on the initial characteristic lifetime and a stress included in the accelerated-stress test; and performing operation processing on the multi-stress coupling acceleration model to obtain the reliability of the target product.

In an embodiment, the computer program, when executed by the processor, may cause the processor to further implement the following steps of:
acquiring a cumulative failure probability density function corresponding to each failure mode of the target product under the accelerated-stress test; constructing the coupling competition failure model of the target product under the accelerated-stress test by using the cumulative failure probability density function corresponding to each failure mode based on a coupling competition relationship between the failure modes.

In an embodiment, the computer program, when executed by the processor, may cause the processor to further implement the following steps of:
taking logarithms of functions on both sides of the coupling competition failure model to obtain a maximum likelihood function corresponding to the coupling competition failure model; solving the maximum likelihood function corresponding to the coupling competition failure model to obtain a solution result of an unknown parameter in the coupling competition failure model.

In an embodiment, the computer program, when executed by the processor, may cause the processor to further implement the following steps of:
acquiring a stress value of each stress applied to each group of target products; substituting an initial characteristic lifetime of each group of target products and the stress value of each stress into a model obtained after a linear transformation of the multi-stress coupling acceleration model, and obtaining an equation group consisting of a plurality of equations; solving the equation group to obtain a solution result of an unknown parameter in the multi-stress coupling acceleration model.

In an embodiment, the computer program, when executed by the processor, may cause the processor to further implement the following steps of:
determining a characteristic lifetime function of the target product; substituting a value of each normal stress into a function term of the characteristic lifetime function, performing operation processing on the function term of the characteristic lifetime function, and obtaining the characteristic lifetime of the target product; determining the mean time between failures of the target product under the normal stresses based on the characteristic lifetime when a distribution of the characteristic lifetime is an exponential distribution; obtaining the reliability of the target product according to a length of the mean time between failures.

In an embodiment, the computer program, when executed by the processor, may cause the processor to further implement the following steps of:
acquiring the number of stresses applied to the target product in the accelerated-stress test; obtaining the characteristic lifetime function of the target product based on the number of stresses and combined with the multi-stress coupling acceleration model and a parameter result of an unknown parameter in the multi-stress coupling acceleration model.

In an embodiment, the computer program, when executed by the processor, may cause the processor to further implement the following steps of:
obtaining a failure rate of the target product under the normal stresses by taking a reciprocal of the characteristic lifetime of the target product.

It should be noted that the user information (including but not limited to user equipment information, user personal information, and the like) and data (including, but not limited to, data for analysis, stored data, displayed data, and the like) are information and data authorized by a user or fully authorized by each party, and the collection, use, and processing of the relevant data requires compliance with the relevant laws, regulations, and standards of the relevant countries and regions.

It will be appreciated by those of ordinary skill in the art that all or part of the procedures for implementing the methods of the embodiments described above may be accomplished by a computer program instructing relevant hardware, the computer program is stored in a non-transitory computer readable storage medium. The computer program, when executed, may implement the process including the procedures in the embodiments of the methods described above. Any reference to a memory, database, or other medium used in the embodiments provided herein may include at least one of a non-transitory memory and a transitory memory. The non-transitory memory may include a Read-Only Memory (ROM), a magnetic tape, a floppy disk, a flash memory, an optical memory, a high-density embedded non-transitory memory, a resistive random access memory (ReRAM), a MagnetoresistiveRandom Access Memory (MRAM), and a Ferroelectric Random Access Memory (FRAM), a PhaseChange Memory (PCM), a graphene memory, and the like. The transitory memory may include a Random Access Memory (RAM) or an external cache memory or the like. By way of illustration and not limitation, RAM may be in a variety of forms, such as a StaticRandom Access Memory (SRAM), a Dynamic Random Access Memory (DRAM), and the like. The databases referred to in the embodiments provided herein may include at least one of a relational database and a non-relational database. The non-relational database may include a block chain-based distributed database or the like, and is not limited thereto. The processor involved in the embodiments provided herein may be a general purpose processor, a central processing unit, a graphics processor, a digital signal processor, a programmable logic unit, a quantum computing-based data processing logic unit, or the like, and is not limited thereto.

Each of the technical features in the above embodiments may be combined arbitrarily. For the sake of brevity, not all possible combinations of each of the technical features in the above embodiments have been described. However, the combinations of these technical features should be considered to be within the scope of the present disclosure as long as they do not contradict each other.

The above-described embodiments merely represent some implementation modes of the present disclosure, are described in more detail and detail, but are not therefore to be construed as limiting the scope of the patent disclosure. It should be noted that several variations and modifications may be made by those of ordinary skill in the art without departing from the spirit and scope of the present disclosure, and all fall with the scope of the present disclosure. Accordingly, the scope of protection of the present disclosure should be subject to the appended claims.

1. A product reliability evaluation method based on a multi-stress coupling acceleration model, comprising:
constructing a coupling competition failure model of a target product under an accelerated-stress test based on cumulative failure probability density functions corresponding to failure modes of the target product under the accelerated-stress test, wherein a cumulative failure probability density function is a change rate function of a cumulative failure probability to time, and the coupling competition failure model is represented as follows:
$$R ( t ) = C ( {R}_{1} ( t ) , {R}_{2} ( t ) , … , {R}_{u} ( t ) , θ ) = 1 - {\sum }_{j = 1}^{n} {F}_{j} ( t ) + {\sum }_{1 \leq j < k \leq t} C ( {F}_{j} ( t ) , {F}_{k} ( t ) , … ) - {\sum }_{1 \leq j \leq k \leq b \leq i} C ( {F}_{j} ( t ) , {F}_{k} ( t ) , {F}_{b} ( t ) , … ) + {( - 1 )}^{n} C ( {F}_{1} ( t ) , {F}_{2} ( t ) , … , {F}_{t} ( t ) ) ,$$
wherein R(t) is a reliability function of the target product, C(*) is a connection function, C(Fⱼ(t), Fₖ(t), . . . ) are connection functions in which all variables except Fⱼ(t) and Fₖ(t) are equal to 1, and θ is an unknown parameter, Fⱼ(t) and Fₖ(t) respectively represent a cumulative failure probability density function of the j-th failure mode and a cumulative failure probability density function of the k-th failure mode, t denotes time for the accelerated-stress test;
substituting a solution result of a parameter in the coupling competition failure model into the coupling competition failure model to obtain the reliability function of the target product;
integrating a function term of the reliability function to obtain an initial characteristic lifetime of the target product under the accelerated-stress test;
determining the multi-stress coupling acceleration model of the target product based on the initial characteristic lifetime and a stress comprised in the accelerated-stress test, wherein the multi-stress coupling acceleration model is represented as
$${η}_{t} = A exp [ B / ( {kT}_{i} ) ] \times exp \{ {\sum }_{j = 1}^{m} {S}_{ij} [ {C}_{j} + {D}_{j} / ( {kT}_{i} ) ] \} ,$$
wherein m represents a total number of stresses except a temperature stress, j=1, 2, . . . , m; Sᵢⱼ denotes a value of the j-th non-temperature stress for the accelerated-stress test of the i-th group of target products; A, B, Cⱼ, and Dⱼ denote unknown parameters, Tᵢ denotes a value of the temperature stress for the accelerated-stress test of the i-th group of target products, ηᵢ denotes an initial characteristic lifetime of the i-th group of target products under the accelerated-stress test, and k is a Boltzmann constant;
performing operation processing on the multi-stress coupling acceleration model to obtain a reliability of the target product.

2. The method according to claim 1, wherein the constructing the coupling competition failure model of the target product under the accelerated-stress test based on the cumulative failure probability density functions corresponding to the failure modes of the target product under the accelerated-stress test comprises:
acquiring a cumulative failure probability density function corresponding to each failure mode of the target product under the accelerated-stress test; and
constructing the coupling competition failure model of the target product under the accelerated-stress test by using the cumulative failure probability density function corresponding to each failure mode based on a coupling competition relationship between the failure modes.

3. The method according to claim 1, further comprising:
before the substituting the solution result of the parameter in the coupling competition failure model into the coupling competition failure model to obtain the reliability function of the target product,
taking logarithms on both sides of the coupling competition failure model to obtain a maximum likelihood function corresponding to the coupling competition failure model; and
solving the maximum likelihood function corresponding to the coupling competition failure model to obtain a solution result of an unknown parameter in the coupling competition failure model.

4. The method according to claim 1, wherein the accelerated-stress test comprises at least two stresses, and there exists at least two groups of target products; and the method further comprises:
after the determining the multi-stress coupling acceleration model of the target product based on the initial characteristic lifetime and the stress comprised in the accelerated-stress test,
acquiring a stress value of each stress applied to each group of target products;
substituting an initial characteristic lifetime of each group of target products and the stress value of each stress into a model obtained after a linear transformation of the multi-stress coupling acceleration model, and obtaining an equation group consisting of a plurality of equations; and
solving the equation group to obtain a solution result of an unknown parameter in the multi-stress coupling acceleration model.

5. The method according to claim 1, wherein the performing the operation processing on the multi-stress coupling acceleration model to obtain the reliability of the target product comprises:
determining a characteristic lifetime function of the target product;
substituting a value of each normal stress into a function term of the characteristic lifetime function, performing the operation processing on the function term of the characteristic lifetime function, and obtaining the characteristic lifetime of the target product, wherein the characteristic lifetime represents a serviceable duration of the target product;
determining mean time between failures of the target product under the normal stresses based on the characteristic lifetime when a distribution of the characteristic lifetime is an exponential distribution; and
obtaining the reliability of the target product according to a length of the mean time between failures.

6. The method according to claim 5, wherein the determining the characteristic lifetime function of the target product comprises:
acquiring the number of stresses applied to the target product in the accelerated-stress test; and
obtaining the characteristic lifetime function of the target product based on the number of stresses and combined with the multi-stress coupling acceleration model and the solution result of the unknown parameter in the multi-stress coupling acceleration model.

7. The method according to claim 1, further comprising:
obtaining a failure rate of the target product under the normal stresses by taking a reciprocal of the characteristic lifetime of the target product, wherein the failure rate represents a probability that the target product fails.

8. A product reliability evaluation apparatus based on a multi-stress coupling acceleration model, comprising:
a coupling competition failure model construction module, configured to construct a coupling competition failure model of a target product under an accelerated-stress test based on cumulative failure probability density functions corresponding to failure modes of the target product under the accelerated-stress test, wherein a cumulative failure probability density function is a change rate function of a cumulative failure probability to time, and the coupling competition failure model is represented as follows:
$$R ( t ) = C ( {R}_{1} ( t ) , {R}_{2} ( t ) , … , {R}_{u} ( t ) , θ ) = 1 - {\sum }_{j = 1}^{n} {F}_{j} ( t ) + {\sum }_{1 \leq j < k \leq t} C ( {F}_{j} ( t ) , {F}_{k} ( t ) , … ) - {\sum }_{1 \leq j \leq k \leq b \leq i} C ( {F}_{j} ( t ) , {F}_{k} ( t ) , {F}_{b} ( t ) , … ) + {( - 1 )}^{n} C ( {F}_{1} ( t ) , {F}_{2} ( t ) , … , {F}_{t} ( t ) ) .$$
wherein R(t) is a reliability function of the target product, ((*) is a connection function, C(Fⱼ(t), Fₖ(t), . . . ) are connection functions in which all variables except Fⱼ(t) and Fₖ(t) are equal to 1, and θ is an unknown parameter, Fⱼ(t) and Fₖ(t) respectively represent a cumulative failure probability density function of the j-th failure mode and a cumulative failure probability density function of the k-th failure mode, t denotes time for the accelerated-stress test;
a reliability function determination module, configured to substitute a solution result of a parameter in the coupling competition failure model into the coupling competition failure model to obtain the reliability function of the target product;
an initial characteristic lifetime calculation module, configured to integrate a function term of the reliability function to obtain an initial characteristic lifetime of the target product under the accelerated-stress test;
a multi-stress coupling acceleration model construction module, configured to determine the multi-stress coupling acceleration model of the target product based on the initial characteristic lifetime and a stress comprised in the accelerated-stress test, wherein the multi-stress coupling acceleration model is represented as
$${η}_{t} = A exp [ B / ( {kT}_{i} ) ] \times exp \{ {\sum }_{j = 1}^{m} {S}_{ij} [ {C}_{j} + {D}_{j} / ( {kT}_{i} ) ] \} ,$$
wherein m represents a total number of stresses other than a temperature stress, j=1, 2, . . . , m, Sᵢⱼ denotes a value of the j-th non-temperature stress for the accelerated-stress test of the i-th group of target products; A, B, Cⱼ, and Dⱼ denote unknown parameters, Tᵢ denotes a value of the temperature stress for the accelerated-stress test of the i-th group of target products, ηᵢ denotes an initial characteristic lifetime of the i-th group of target products under the accelerated-stress test, and k is a Boltzmann constant;
a reliability obtaining module, configured to perform operation processing on the multi-stress coupling acceleration model to obtain a reliability of the target product.

9. A computer device, comprising a processor and a memory storing a computer program, wherein the processor, when executing the computer program, implements the method of any one of claim 1.

10. A computer-readable storage medium, on which a computer program is stored, wherein when the computer program is executed by a processor, the processor is caused to implement the method of any one of claim 1.
